(19) United States
(12) Patent Application Publication
(10) Pub. No.: US 2023/0166973 A1
(43) Pub. Date: Jun. 1, 2023

(54) NEGATIVE ELECTRODE MATERIAL FOR A LITHIUM ION BATTERY

(71) Applicant: UEA Enterprises Limited, Norwich (GB)

(72) Inventor: Yimin CHAO, Norwich (GB)

(21) Appl. No.: 17/995,795

(22) PCT Filed: Apr. 9, 2021
(86) PCT No.: PCT/GB2021/050873

§ 371 Date: Oct. 7, 2022

(30) Foreign Application Priority Data
Apr. 9, 2020 (GB) 2005314.6

(51) Int. Cl. C01B 32/05; H01M 10/0525

(52) U.S. Cl. CPC C01B 32/05; H01M 10/0525; C01P 2006/40

(57) ABSTRACT

A method of making a negative electrode material for a lithium ion battery, the method comprising: subjecting barley husks to a carbonization process to form carbonized barley husk material; grinding the carbonized barley husk material.

### FIELD OF THE INVENTION

The present invention relates to a negative electrode material for a lithium ion battery, electrodes comprising this material, and lithium batteries containing the electrode comprising the material.

### BACKGROUND

Lithium ion batteries are constantly being developed. They generally comprise a positive electrode, which comprises a material containing mobile lithium ions, and a negative electrode (sometimes termed the anode), to which the lithium ions can flow and be retained, until the current flow is reversed. The materials for negative electrodes have to be able to reversibly intercalate lithium over many cycles, ideally with low volume expansion. Numerous materials have been used, including carbon-based materials, lithium titanate, tin/cobalt alloys and silicon nanowires. These materials have been successful to varying degrees, but they can be expensive to mass produce.

There is a desire to create improved lithium ion batteries, and battery materials, which may be an alternative to, ideally an improvement upon, those in the prior art and be very economical to produce.

### SUMMARY

In a first aspect, the present disclosure relates to a method of making a negative electrode material for a lithium ion battery, the method comprising:
subjecting barley husks, which may be in ground form, to a carbonization process to form carbonized barley husk material;
grinding the carbonized barley husk material. The method may further involve doping the carbonized barley husk material with nitrogen.

In a second aspect, the present disclosure relates to a negative electrode material comprising a carbonized, ground barley husk material. Optionally the carbon of the carbonized, ground barley husk material has been doped with nitrogen. The negative electrode material may further comprise a binder and an electrically conductive material.

In a third aspect, the present disclosure relates to a negative electrode for a lithium ion battery, the electrode comprising
a substrate comprising a material comprising a carbonized, ground barley husk material. The carbonized, ground barley husk material comprises carbon.
Optionally, the carbon of the carbonized, ground barley husk material has been doped with nitrogen.

In a fourth aspect, the present disclosure relates to a lithium ion battery, the lithium ion battery, comprising:
a positive electrode comprising a material containing lithium ions;
a negative electrode comprising:
a substrate comprising a material comprising a carbonized, ground barley husk material. Optionally, the carbon of the carbonized barley husk material has been doped with nitrogen.

The present inventor has found that a negative electrode material can be made from barley husks. Barley husks are, normally, a waste product from many processes that involve the use of barley grain, such as beer production or producing animal food. Accordingly, barley husks are a readily available and cheap material, and derive from a sustainable resource. The present inventors have found that a material having suitable properties for use in or as a negative electrode can be made by suitable processing of barley husks. This is believed to be, in part, because of a relatively high amount of silicon found in the husks. The husks can be carbonised, e.g. in a pyrolyzing atmosphere, converting much of the organic material to elemental carbon, and then crushed. The resultant composite, which contains both elemental carbon and silicon, which may be the form of SiO₂, is able to intercalate lithium and act as a negative electrode material. The present inventors found that doping the material with nitrogen increases its electrochemical performance, in terms of reversible capacity, high-rate performance and long-term cyclic capability, e.g. over 1000 or more cycles.

### BRIEF DESCRIPTION OF THE FIGURES

FIG. 1 illustrates schematically an example of a process for making an example of the material as described herein.

FIG. 2 illustrates the cycling performance of electrodes as described herein in Example 1, each comprising an example of the material as described herein at a current density of 1.0 A g⁻¹ and a voltage range of 0-3 V over 1000 cycles.

FIG. 3 is a schematic diagram of a coin cell assembly containing the material as described herein in the negative electrode (the anode).

FIG. 4 is a SEM image from as-prepared negative electrode (anode) material of Example 2.

FIG. 5 is EDS from the same material as FIG. 4.

FIG. 6 shows XRD data, which confirms silicon components within the samples.

FIG. 7 shows the cycling performances of electrodes comprising materials from Example 2, at a current density of 1.0 A g⁻¹ over 200 cycles and a voltage range of 0-3 V.

### DETAILED DESCRIPTION

The present disclosure provides the aspects described herein. Optional and preferable features of the aspects are given below. These optional and preferable features are, unless indicated, otherwise applicable to all aspects. Any optional or preferred feature may be combined with any other optional or preferred feature.

Barley is a grain that is grown in temperate climates across the world. Barley is within the grass family, and comprises the commonly grown domestic species, Hordeum vulgare, and its ancestor, wild barley (Hordeum spontaneum). Both wild barley and domestic barley, for the purpose of this disclosure, are included under the definition of barley. A barley grain typically comprises an outer hull or husk, i.e. a typically fibrous and inedible shell of the grain that would normally be removed for the production of food or beverages, and an inner part, comprising the bran, endosperm and germ.

In a first aspect, the present disclosure relates to a method of making a negative electrode material for a lithium ion battery, the method comprising:
subjecting barley husks, which may be in ground form, to a carbonization process to form carbonized barley husk material;
grinding the carbonized barley husk material. The method may further involve doping the carbonized barley husk material with nitrogen.

In an embodiment, there is provided a method of making a negative electrode material for a lithium ion battery, the method comprising:
subjecting barley husks to a carbonization process to form carbonized barley husk material;
grinding the carbonized barley husk material,
wherein the barley husks have also been ground before they are subjected to a carbonization process,
and wherein the method further involves doping the carbonized barley husk material with nitrogen, such that nitrogen-doped carbon is formed, optionally wherein the method involves contacting the carbonized barley husk material with a nitrogen source until nitrogen-doped carbon is formed. There is also provided a negative electrode material formable by this method.

In an embodiment, there is provided a method of making a negative electrode material for a lithium ion battery, the method comprising:
subjecting barley husks to a carbonization process to form carbonized barley husk material;
grinding the carbonized barley husk material,
wherein the barley husks have also been ground before they are subjected to a carbonization process,
wherein the husks are subjected to an acid treatment before carbonization, optionally wherein the acid used in the acid treatment is an acid having a pKa in water of −2 or less,
and wherein the method further involves doping the carbonized barley husk material with nitrogen, such that nitrogen-doped carbon is formed, optionally wherein the method involves contacting the carbonized barley husk material with a nitrogen source until nitrogen-doped carbon is formed. There is also provided a negative electrode material formable by this method.

In an embodiment, there is provided a method of making a negative electrode material for a lithium ion battery, the method comprising:
subjecting barley husks to a carbonization process to form carbonized barley husk material;
grinding the carbonized barley husk material,
wherein the barley husks have also been ground before they are subjected to a carbonization process,
wherein the husks are subjected to an acid treatment before carbonization, wherein the acid used in the acid treatment is an acid having a pKa in water of −2 or less,
and wherein the method further involves doping the carbonized barley husk material with nitrogen, such that nitrogen-doped carbon is formed, and wherein the method involves contacting the carbonized barley husk material with a nitrogen source until nitrogen-doped carbon is formed. optionally wherein the nitrogen source is selected from ammonia, a nitrogen-containing heterocycle, a hydrazine and urea. There is also provided a negative electrode material formable by this method.

In an aspect, there is provide a negative electrode material comprising a carbonized, ground barley husk material.

In an embodiment, there is provided a negative electrode material comprising a carbonized, ground barley husk material, wherein the carbon of the carbonized, ground barley husk material has been doped with nitrogen, wherein the negative electrode material further comprises a binder and/or an electrically conductive material. The negative electrode material may be formable by any of the methods described herein.

Preferably, the barley husks, prior to carbonisation, have not been subjected to an oxidising process, e.g. by oxidising the barley husks in air, e.g. by burning the husks; the husks may nevertheless have been ground before or after carbonisation. The barley husks may be discarded barley husks from an industrial or food- or beverage-production process. For example, the barley husks may be husks discarded in a brewing process (with the husks either removed from the grain before or after the barley has been subjected to the brewing process). Optionally, prior to carbonisation, the barley husks have not been subjected to a chemical modification process (except for the acid treatment described herein; grinding is not considered a chemical modification process in the present context).

Before and/or after carbonization, the husks may be ground. If grinding before, the grinding may be carried out to reduce the husks such that at least some of particles are of a size of millimeters or micrometers, e.g. to a size of 3 mm or less, optionally 2 mm or less, optionally 1 mm or less, optionally 0.5 microns or less, optionally 0.2 mm or less, optionally 0.1 mm or less, optionally 0.1 mm to 3 mm, optionally 0.1 mm to 2 mm, optionally 0.1 mm to 1 mm; and this may be carried out using any suitable technique, e.g. by placing the husks in a device that crushes them, which may be mechanical or by human means, including, but not limited to, devices such as a grinding machines or a mill, which may include ball mills or mills having one surface move past another, or manual a device such as a pestle and mortar. “At least some of particles” may indicate that at least 50% by number of the particles, from a sample of 100 of the particles, have the stated particle size or size range, as measured by a suitable measurement means, such as an optical microscope. The measurement of the size of any particle will be the largest dimension of the particle as visible using the chosen viewing technique.

Preferably, the husks are subjected to an acid treatment before carbonization (and, if an initial grinding has taken place, after the initial grinding). The purpose of the acid treatment is to remove metal impurities from the husks. The acid treatment may involve contacting the husks with an acid. The acid may be a strong acid, which may be an acid having a pKa in water (at 25 Deg C. and standard pressure) of −2 or less (i.e. greater negative value). The acid may be a mineral acid or inorganic acid, such as an acid selected from HCl, HNO₃, H₃PO₄, H₂SO₄, H₃BO₃, HF, HBr, HClO₄ and HI. The acid may be in a liquid carrier such as water and have a molarity of 0.1 M to 5 M, optionally 0.5 M to 2 M, optionally about 1 M. The acid treatment may involve contacting the husks with an acid for a period of at least 15 minutes, optionally at least 30 minutes, optionally at least 1 hour, optionally from 15 minutes to 5 hours, optionally from 15 minutes to 3 hours, optionally from 30 minutes to 3 hours, optionally from 1 hour to 3 hours, optionally 1.5 hours to 2.5 hours. The acid treatment may involve contacting the husks with an acid, which may be an acid having a pKa in water (at 25 Deg C. and standard pressure) of −2 or less, for a period of at least 15 minutes, optionally at least 30 minutes, optionally at least 1 hour, optionally at least 2 hours, optionally at least 5 hours, optionally at least 10 hours, optionally at least 15 hours, optionally at least 20 hours, optionally at least 22 hours, optionally at least 23 hours, optionally at least 24 hours. The acid treatment may involve contacting the husks with an acid, which may be an acid having a pKa in water (at 25 Deg C. and standard pressure) of −2 or less, for a period of from 15 minutes to 48 hours, optionally for a period of from 1 hour to 48 hours, optionally for a period of from 2 hours to 48 hours, optionally for a period of from 3 hours to 48 hours, optionally for a period of from 4 hours to 48 hours, optionally from a period of 5 hours to 48 hours, optionally for a period of from 10 hours to 48 hours, optionally for a period of from 10 hours to 36 hours, optionally for a period of from 15 hours to 36 hours, optionally for a period of from 20 hours to 30 hours, optionally for a period of from 20 hours to 28 hours, optionally for a period of from 22 to 26 hours, optionally about 24 hours. Subjecting the barley husks to a longer acid treatment was found, together with the other steps in the method, to raise the specific capacity of the material.

As part of the acid treatment, the barley husks may be subjected to wash treatment, after being contacted with the acid. The wash treatment may involve, contacting the barley husks with a liquid, e.g. water, which is not the same liquid used for the acid-treatment, and then removal of the liquid. This may involve placing the barley husks on a filter and allowing the liquid to pass over the barley husks. The liquid may be water having a pH of from 5 to 9, e.g. 6 to 8, e.g. about 7. The removal of the liquid may involve allowing the liquid to evaporate, which may involve placing the barley husks in a heated atmosphere, e.g. at a temperature of more than 30° C., e.g. a temperature of from 30° C. to 200° C., optionally a temperature of from 30° C. to 150° C., optionally a temperature of from 30° C. to 130° C., optionally a temperature of from 30° C. to 100° C., optionally a temperature of from 60° C. to 100° C., optionally a temperature of from 70° C. to 90° C., optionally about 80° C. The barley husks may be dried for a period that allows substantial removal of liquid, e.g. from acid and/or the wash treatment, e.g. removal of at least about 95 wt %, optionally at least about 99 wt %, optionally about 100 wt % of the liquid.

The husks, which may have been ground and subjected to an acid treatment, may be subjected to a carbonization process to form a carbonized barley husk material. The carbonization process may be a pyrolyzation process, e.g. by placing the barley husk material in a pyrolyzing atmosphere. The carbonization process preferably converts at least some of the organic matter within the husk to elemental carbon, which may be graphitic or non-graphitic carbon, e.g. hard carbon. The carbonization may be carried out by subjecting the husks to a heat treatment in a non-oxidising atmosphere, e.g. in an inert atmosphere, e.g. in the atmosphere of an inert gas. The inert gas may be selected from a noble gas, e.g. from Group 18 in the period table, and nitrogen. Group 18 of the period table includes helium, neon and argon. The heat treatment may be a treatment at a temperature of 400° C. or more, optionally 500° C. or more, optionally 550° C. or more, optionally 600° C. or more, optionally from 400° C. to 800° C., optionally from 500° C. to 800° C., optionally from 550° C. to 800° C., optionally from 600° C. to 800° C., optionally from 400° C. to 750° C., optionally from 500 to 700° C., optionally from 550° C. to 700° C., optionally from 600 to 700° C., optionally about 650° C. The heat treatment may be carried out for a period of at least 30 minutes, optionally at least 1 hour, optionally from 15 minutes to 5 hours, optionally from 15 minutes to 3 hours, optionally from 30 minutes to 3 hours, optionally from 1 hour to 3 hours, optionally 1.5 hours to 2.5 hours. In the heating, the temperature may be raised at a steady rate until the desired temperature is reached. The temperature may be raised at a rate of from 0.5° C. min⁻¹ to 10° C. min⁻¹, optionally from 2° C. min⁻¹ to 8° C. min⁻¹, optionally from 3° C. min⁻¹ to 7° C. min⁻¹, optionally from 2° C. 4° C. min⁻¹, optionally about 3° C.

The grinding of the barley husk material, as mentioned, may be carried out before and/or after the carbonization. If carried out after the carbonization, the grinding is preferably carried out to reduce at least some of the particles to micrometer or nanometer scale, e.g. such that at least some of the particles are less than 1 mm, optionally less than 500 microns, optionally less than 100 microns, optionally less than 50 microns, optionally less than 10 microns, optionally less than 1 micron, optionally less than 0.9 microns, optionally less than 0.5 microns, optionally less than 0.1 microns. The composition may comprise carbon particles and silica particles. The carbon particles are preferably of the micron scale (e.g. 1 micron to 0.9 mm, optionally 1 micron to 500 microns) and the silica particles are preferably of the nanometer scale (e.g. 1 nm to 999 nm). “At least some of particles” may indicate that at least 50% by number of the particles, from a sample of 100 of the particles, have the stated particle size or size range, as measured by a suitable measurement means, such as an optical microscope or a scanning electron microscope. The measurement of the size of any particle will be the largest dimension of the particle as visible using the chosen viewing technique. The grinding may be carried out, for example, in a grinding device, e.g. a grinding machine, e.g. any of those mentioned above, which may be a ball mill. The grinding may be carried out in a ball mill with grinding media, e.g. ceramic or metal media, e.g. in the form of balls. The grinding media may, for example, comprise silicon nitride, which may be in the form of balls. The grinding media may have a dimension (e.g. diameter, if spherical, or otherwise the largest dimension of an object) of from 5 mm to 20 mm, optionally 5 mm to 15 mm, optionally 8 mm to 12 mm, optionally about 10 mm. The grinding may be carried out for a period of at least 1 hour, optionally at least 2 hours, optionally at least 3 hours, optionally at least 4 hours, optionally at least 5 hours, optionally from 2 to 10 hours, optionally from 4 to 8 hours, optionally from 5 to 7 hours, optionally about 6 hours. The ball mill may rotate at a speed of at least 200 rpm, optionally at least 300 rpm, optionally at least 400 rpm, optionally at least 500 rpm, optionally from 200 rpm to 1200 rpm, optionally from 500 rpm to 1100 rpm, optionally from 600 rpm to 1000 rpm, optionally from 700 rpm to 900 rpm. The grinding may be carried out in a ball mill with silicon nitride media balls, optionally with a diameter of from 5 mm to 15 mm, for a period of from 4 hours to 8 hours, at a rotation speed of from 600 rpm to 1000 rpm.

The method may further involve doping the carbonized barley husk material with nitrogen. This may involve forming nitrogen-doped carbon material. The nitrogen-doped material may be produced by contacting the carbonized barley husk material with a nitrogen source until nitrogen-doped carbon is formed. The nitrogen source may be, for example exposure of the carbonized barley husk material to a nitrogen-containing gas or liquid. The nitrogen-containing gas may, for example, comprise ammonia. The nitrogen source may be a nitrogen-containing heterocycle, such as melamine. The nitrogen source may comprise a nitrogen-containing reducing agent such as a material selected from a hydrazine, such as hydrazine hydrate, and urea. The contacting of the carbonized barley husk material with a nitrogen source may be carried out at a raised temperature, e.g. at 70° C. or above, e.g. at a temperature of 100° C. or above, optionally a temperature of 200° C. or above, optionally at a temperature of 300° C. or above, optionally at a temperature of 400° C. or above, optionally at a temperature of 500° C. or above, optionally at a temperature of 600° C. or above, optionally at a temperature of from at 70° C. to 1000° C., optionally at a temperature of from 200° C. to 1000° C., optionally at a temperature of from 300° C. to 900° C., optionally at a temperature of from 400° C. to 800° C., optionally at a temperature of from 500° C. to 800° C., optionally at a temperature of from 550° C. to 750° C., optionally at a temperature of about 650° C. The contacting may be carried out for a period of from 5 minutes to 5 hours, optionally 5 minutes to 2 hours, optionally 15 minutes to 1 hour, optionally 15 minutes to 45 minutes. Optionally, the carbonized barley husk material is contacted with a solid or liquid nitrogen source, such as urea or melamine, and then heated, which may be in an atmosphere of an inert gas, at a temperature of from of from 400° C. to 800° C., optionally at a temperature of from 500° C. to 800° C., optionally at a temperature of from 550° C. to 750° C., optionally at a temperature of about 650° C., for a period of from 5 minutes to 2 hours, optionally 15 minutes to 1 hour, optionally 15 minutes to 45 minutes. In the heating, the temperature may be raised at a steady rate until the desired temperature is reached. The temperature may be raised at a rate of from 0.5° C. min⁻¹ to 10° C. min⁻¹, optionally from 0.5° C. min⁻¹ to 5° C. min⁻¹, optionally from 1° C. min⁻¹ to 5° C. min⁻¹, optionally from 2° C. min⁻¹ to 4° C. min⁻¹, optionally about 3° C. min⁻¹.

In a second aspect, the present disclosure relates to a negative electrode material comprising a carbonized, ground barley husk material. Optionally the carbon of the carbonized, ground barley husk material has been doped with nitrogen. The negative electrode material may further comprise a binder and/or electrically conductive material. The binder may comprise a polymeric material, which may be selected from a fluorinated polymeric material, a gelling polymeric material and a rubber. The binder may comprise a material selected from polyvinylidene fluoride (PVDF), polytetrafluoroethylene (PTFE), sodium carboxymethylcellulose (CMC), acrylonitrile-butadiene rubber, styrene-butadiene rubber (SBR) and methyl methacrylate rubber. The electrically conductive material may comprise particles comprising a metal (in elemental or alloyed form) or carbon (which is different from the carbonized, ground barley husk material). The particles comprising carbon (carbon particles) may comprise carbon in the form of graphite, carbon black, pyrolyzed carbon, acetylene black, coke, activated carbon, carbon fiber, a fullerene, petroleum coke, hard carbon, and carbon nanotubes. The electrically conductive material may comprise particles comprising a metal in elemental or alloyed form; the metal may be selected from a transition metal. The electrically conductive material, which may be in particulate form, may comprise a metal, in elemental or alloyed form, selected from Ni, Ti, Al, Cu, Pt, Fe, Cr, Sn, Zn, In, and Sb.

In a third aspect, the present disclosure relates to a negative electrode for a lithium ion battery, the electrode comprising
a substrate comprising a material a comprising a carbonized, ground barley husk material. Optionally, the carbon of the carbonized, ground barley husk material has been doped with nitrogen. The negative electrode may comprise a substrate comprising an electrically conductive material, the substrate having coated on a surface thereof the a carbonized, ground barley husk material, which may have been doped with nitrogen.

The electrically conductive material of the substrate may be selected from a metal in elemental or alloyed form and carbon; the metal may be selected from a transition metal, optionally the metal is selected from aluminum, nickel, iron, which may be in pure or alloyed form such as, stainless steel, titanium and copper. The substrate may be termed a current collector. The substrate may have a thickness of from 1 to 100 μm.

In a fourth aspect, the present disclosure relates to a lithium ion battery, the lithium ion battery comprising:
a positive electrode comprising a material containing lithium ions;
a negative electrode comprising:
a substrate comprising a material a comprising a carbonized, ground barley husk material. Optionally, the carbon of the carbonized barley husk material has been doped with nitrogen.

The positive electrode comprises a material containing lithium ions. The positive electrode material may comprise a lithium-containing substance selected from LiFePO₄, Li₃V₂(PO₄)₃, LiMn₂O₄, LiMnO₂, LiNiO₂, LiCoO₂, LiVPO₄F or LiFeO₂; or the ternary system Li₁₊ₐ L_{1-b-c}M_{b}N_{c}O₂, in which −0.1<a≤0.2, 0≤b≤1, 0≤c≤1, 0≤b+c≤1.0, and L, M, N are one or more selected from the group consisted of Co, Mn, Ni, Al, Mg, Ga, Sc, Ti, V, Cr, Fe, Cu and Zn. The positive electrode may comprise a material selected from lithium nickel manganese cobalt oxide, lithium nickel cobalt aluminium oxide and lithium manganese oxide. The positive electrode material may further comprise a binder and/or electrically conductive material (which may be the same as the binder and/or electrically conductive material for the negative electrode).

A separator may be disposed between the positive and negative electrodes. The separator may be electrically insulating and have capacity to hold a liquid, e.g. a non-aqueous electrolyte. The separator may comprise a porous, non-electrically conductive material. The separator may, for example, be a separator selected from a polyolefin (e.g. polyethylene or polypropylene) microporous membrane, a non-woven fabric, e.g. a polyethylene felt and glass fiber felt, superfine glass fiber paper and a porous plate.

A non-aqueous electrolyte may also be disposed between the positive and negative electrodes. The non-aqueous electrolyte may be a solution formed by a lithium salt electrolyte in non-aqueous solvent. The lithium salt electrolyte can be selected from one or more selected from the group consisted of lithium hexafluorophosphate (LiPF₆), lithium perchlorate (LiClO₄), lithium tetrafluoroborate (LiBF₄), lithium hexafluoroarsenate (LiAsF₆), lithium hexafluoro silicate (LiSiF₆), lithium tetraphenylborate (LiB(C₆Hs)₄), lithium chloride (LiCl), lithium bromide (LiBr), lithium chloroaluminate (LiAlCl₄), lithium triflate (LiCF₃SO₃), Lithium nickel manganese cobalt oxide, lithium nickel cobalt aluminium oxide (LiNiCoAlO₂), lithium manganese oxide (LiMn₂O₄) lithium iron phosphate (LiFePO₄), lithium cobalt oxide (LiCoO₂) and Li(C₂F₅SO₂)₂N; the non-aqueous solvent can be selected from ethers, esters, alkyl carbonates, inorganic solvents, and suitable organic solvents. The ether may be selected from polyethers, such as polyethylene oxides, cyclic ethers such as tetrahydrofuran and cyclic acetals such as 1-3 dioxolane. The esters may be selected from methyl formate, ethyl acetate, γ-butyrolactone (γ-BL), and rolactone. The alkyl carbonates may be selected from ethylene carbonate (EC), propylene carbonate (PC), butylene carbonate (BC), dimethyl carbonate (DMC), diethyl carbonate (DEC), ethyl methyl carbonate (EMC), methyl propyl carbonate (MPC), dipropyl carbonate (DPC), and vinylene carbonate (VC). The inorganic solvents may be selected from SO₂, Cl₂SO, SO₂Cl₂. Suitable organic solvents may be selected from acetonitrile, nitromethane, N,N-dimethyl formamide, dimethyl sulphoxide, sulfolane and methyl chloride. In the non-aqueous electrolyte, the concentration of the lithium salt electrolyte can be 0.1-2 mol/L, preferably 0.8-1.2 mol/L.

The battery may be a re-chargeable or secondary battery. The battery may be charged by any suitable means, including, but not limited to, solar power, other battery or cells (not necessarily a lithium ion battery), or mains electricity. Once charged, the battery may be discharged as desired.

The battery may be of any suitable configuration; in an embodiment, the battery is in a configuration selected from a button cell, coin cell, pouch cell, prismatic cell, flat cell, cylindrical cell, thin film cell, sealed cell, and a wound cell.

### EXAMPLES

### Example 1

### Materials Fabrication

After grinding and washing with water, barley husks (BHs), in an amount of about 100 g, obtained in Norfolk, were immersed in 1 L of 1 M HCl at 100° C. for two hours to eliminate the metal impurities, and then were collected by filtration and washing with deionized water, drying at a temperature of 120° C. overnight. Subsequently, BHs were calcined in Ar gas at 650° C. for 2 h with a heating rate of 5° C. min⁻¹. Naturally cooled down to room temperature, the powder (BH—SiO₂/C) and silicon nitride balls (10 mm) were transferred to the silicon nitride vial to perform the mechanical milling for 6 h at a rotating speed of 800 rpm. For the N-doping process, 0.4 g as-obtained composites (BH—SiO₂/C) and 0.5 g urea were fully mixed and ground in a mortar for 30 min. Afterwards, the mixture was placed in a quartz crucible and heated in a tube furnace under Ar gas flow at 650° C. for 1 h with the ramp rate of 3° C. min⁻¹. After cooling down to room temperature, the N-doped composites (BH—SiO₂/NC) were obtained.

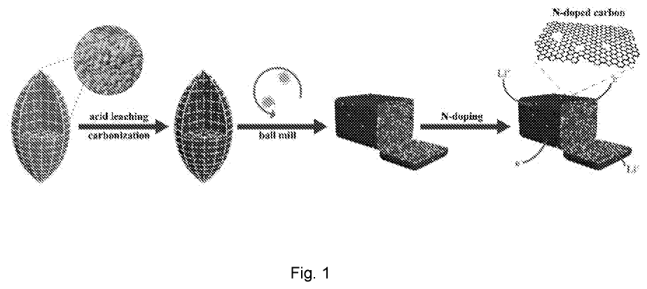

A schematic diagram illustrating the process can be found in FIG. 1.

### Making a Battery Using the Barley Husk-Derived Materials

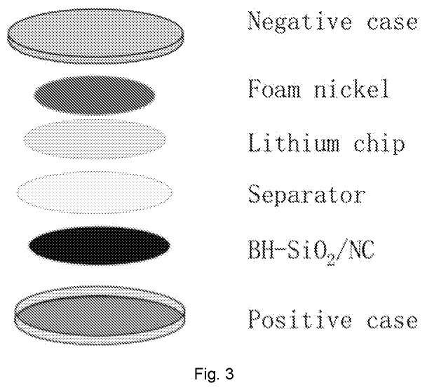

The working electrodes were fabricated by casting slurry containing active barley husk-derived material, a conductive additive (acetylene black) and binder (polyvinylidene fluoride) with a weight ratio of 8:1:1 on copper foil current collector, followed by drying in a vacuum oven at 80° C. for 12 h. The electrochemical properties of the as-prepared samples were carried out using 2016 coin-type cells assembled in an argon-filled glovebox (<0.2 ppm of oxygen and water). Lithium metal was applied as the counter electrode, the microporous membrane (Celgard 2500) as separator and 1 M LiPF6 in the dimethyl carbonate/ethylene carbonate (1:1 v/v) as the electrolyte. A schematic diagram of the battery cell is shown in FIG. 3, which shows the negative case, the foam nickel, the lithium chip, the separator, the active barley husk-derived material (which may be BH—SiO₂/NC) as the anode/negative electrode and the positive case.

### Results

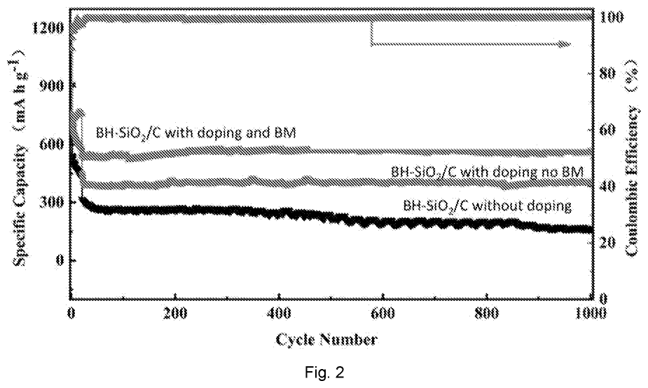

The cycling performances of electrodes comprising materials according to the disclosure were obtained at a current density of 1.0 A g⁻¹ over 1000 cycles and a voltage range of 0-3 V. The materials tested were: the pyrolyzed/carbonised barley husks without doping with nitrogen (BH—SiO₂/C) but ball milled; the pyrolyzed/carbonised barley husks with doping with nitrogen (BH—SiO₂/C) but no ball milling; and the pyrolyzed/carbonised barley husks with doping with nitrogen and with ball milling (BH—SiO₂/C). The results are shown in FIG. 2. In the cycling data in FIG. 2, the top line relates to the right-hand y-axis, i.e. coulombic efficiency for BH—SiO₂/C with doping and ball milling. The bottom three lines relate to the left-hand y-axis, i.e. specific capacity. The annotations on the bottom three lines show to which material they relate.

### Example 2

### Materials Fabrication

After grinding and washing with water, barley husks (BHs), in an amount of about 100 g, obtained in Norfolk, were immersed in 1 L of 1 M HCl at 60° C. for 24 hours to eliminate the metal impurities, and then were collected by filtration and washing with deionized water, drying at a temperature of 80° C. overnight. Subsequently, BHs were calcined in N₂ gas at 650° C. for 2 h with a heating rate of 5° C. min⁻¹. Naturally cooled down to room temperature, the powder (BH—SiO₂/C) and silicon nitride balls (10 mm) were transferred to the silicon nitride vial to perform the mechanical milling for 8 h at a rotating speed of 800 rpm. For the N-doping process, 0.4 g as-obtained composites (BH—SiO₂/C) and 0.5 g urea were fully mixed and ground in a mortar for 30 min. Afterwards, the mixture was placed in a quartz crucible and heated in a tube furnace under N₂ gas flow at 650° C. for 1 h with the ramp rate of 3° C. min⁻¹. After cooling down to room temperature, the N-doped composites (BH—SiO₂/NC) were obtained.

### Results

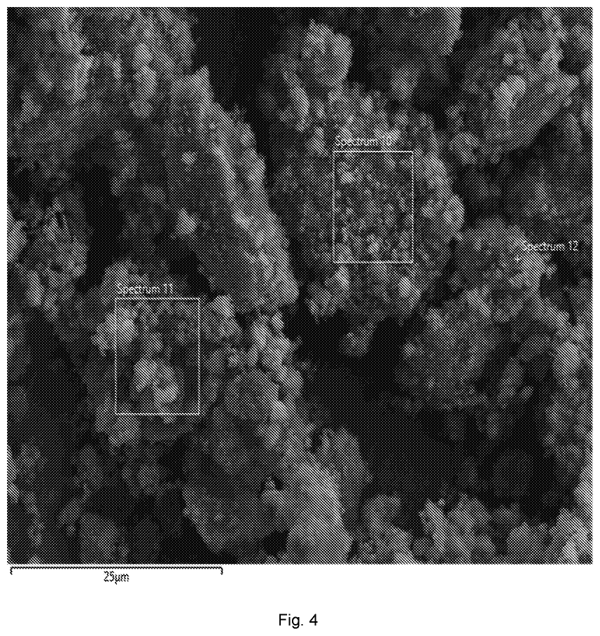

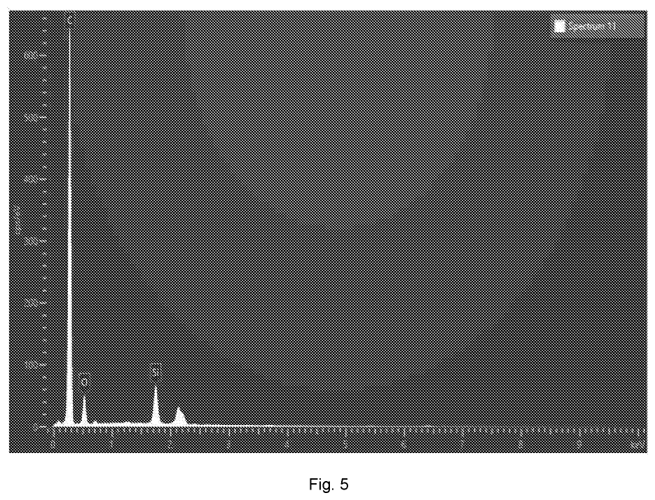

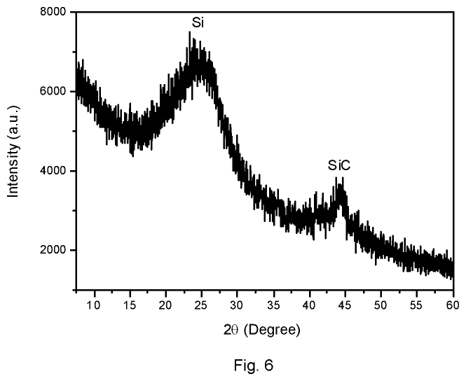

FIG. 4 is a SEM image from as-prepared anode materials, while FIG. 5 is EDS from the same sample. From there one can clearly see silicon, oxygen and carbon components. An XRD data displayed in FIG. 6 confirmed silicon components within the samples.

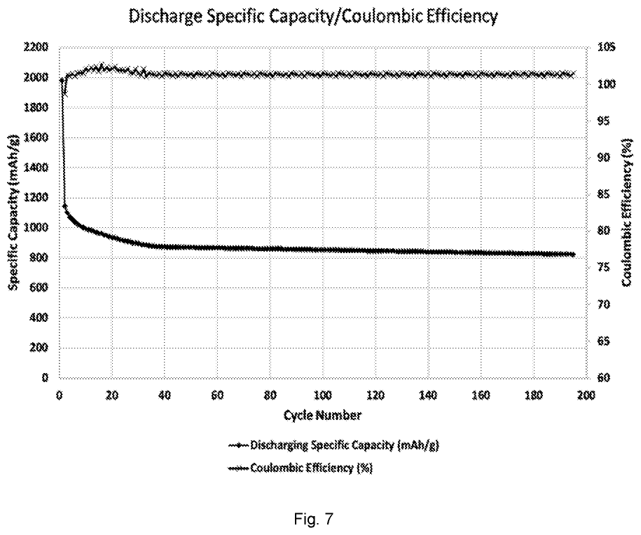

The cycling performances of electrodes comprising materials according to Example 2 were obtained at a current density of 1.0 A g⁻¹ over 200 cycles and a voltage range of 0-3 V. The materials tested were: the pyrolyzed/carbonised barley husks with doping with nitrogen and with ball milling (BH—SiO₂/C). The results are shown in FIG. 7. In the cycling data, the top line relates to the right-hand y-axis, i.e. coulombic efficiency for BH—SiO₂/C with doping and ball milling. The bottom line relates to the left-hand y-axis, i.e. specific capacity.

1. A method of making a negative electrode material for a lithium ion battery, the method comprising:
subjecting barley husks to a carbonization process to form carbonized barley husk material;
grinding the carbonized barley husk material.

2. The method according to claim 1, wherein the barley husks have been ground before they are subjected to a carbonization process.

3. The method according to claim 1 or claim 2, wherein the husks are subjected to an acid treatment before carbonization.

4. The method according to claim 3, wherein the acid used in the acid treatment is an acid having a pKa in water of −2 or less.

5. The method according to any one of the preceding claims, wherein the carbonization is carried out by subjecting the husks to a heat treatment in a non-oxidising atmosphere.

6. The method according to any one of the preceding claims, wherein the carbonization is carried out by subjecting the husks to a heat treatment in the atmosphere of an inert gas.

7. The method according to claim 5 or claim 6, wherein the heat treatment is a treatment at a temperature of from 400° C. to 800° C. for a period of from 15 minutes to 5 hours.

8. The method according to any one of the preceding claims, wherein the method further involves doping the carbonized barley husk material with nitrogen, such that nitrogen-doped carbon is formed.

9. The method according to claim 8, wherein the method involves contacting the carbonized barley husk material with a nitrogen source until nitrogen-doped carbon is formed.

10. The method according to claim 9, wherein the nitrogen source is selected from ammonia, a nitrogen-containing heterocycle, a hydrazine and urea.

11. The method according to claim 9 or claim 10, therein the contacting of the carbonized barley husk material with the nitrogen source is carried out at 70° C. or above, optionally from of from 300° C. to 900° C., for a period of from 5 minutes to 5 hours.

12. The method according to any one of the preceding claims, wherein grinding the carbonized barley husk material involves grinding the carbonized barley husk material in a ball mill.

13. The method according to claim 12, wherein the grinding is carried out with ceramic or metal media having a dimension of from 5 mm to 20 mm, for a period of from 2 to 10 hours at a rotational speed of from 500 rpm to 1100 rpm.

14. A negative electrode material comprising a carbonized, ground barley husk material.

15. The negative electrode material according to claim 14, further comprising a binder and/or an electrically conductive material.

16. The negative electrode material according to claim 15, wherein the binder is selected from polyvinylidene fluoride (PVDF), polytetrafluoroethylene (PTFE), sodium carboxymethylcellulose (CMC), acrylonitrile-butadiene rubber, styrene-butadiene rubber (SBR) and methyl methacrylate rubber.

17. The negative electrode material according to claim 15 or claim 16, wherein the electrically conductive material comprises particles comprising a material selected from a metal in elemental or alloyed form and carbon, which is different from the carbonized, ground barley husk material.

18. The negative electrode material according to any one of claims 15 to 17, wherein the carbon of the carbonized, ground barley husk material has been doped with nitrogen.

19. The negative electrode material according to any one of claims 15 to 18, wherein the negative electrode material is formable in a method as defined in any one of claims 1 to 13.

20. A negative electrode for a lithium ion battery, the electrode comprising
a substrate comprising a material comprising a carbonized, ground barley husk material.

21. The negative electrode according to claim 20, wherein the carbon of the carbonized, ground barley husk material has been doped with nitrogen and/or the material is a negative electrode material formable in a method as defined in any one of claims 1 to 13.

22. A lithium ion battery, comprising:
a positive electrode comprising a material containing lithium ions;
a negative electrode comprising:
a substrate comprising a material a comprising a carbonized, ground barley husk material.

23. A lithium ion battery according to claim 22, wherein the carbon of the carbonized barley husk material has been doped with nitrogen and/or the material is a negative electrode material formable in a method as defined in any one of claims 1 to 13.
